(19) United States
(12) Patent Application Publication
(10) Pub. No.: US 2012/0016778 A1
(43) Pub. Date: Jan. 19, 2012

(54) CONTROLLING CLOUD SERVICES

(76) Inventors: Mathias Salle, San Francisco, CA (US); Erik L. Eidt, Campbell, CA (US); Yassine Faire, Champagnier (FR); Jack S. Walicki, Half Moon Bay, CA (US); Russell Daniels, San Francisco, CA (US)

(21) Appl. No.: 13/258,751

(22) PCT Filed: Jul. 28, 2009
(86) PCT No.: PCT/US09/51989

§ 371 Date: Sep. 22, 2011

(51) Int. Cl. G06F 3/048; G06Q 30/00; G06F 15/16

(52) U.S. Cl. 705/27.1; 715/736

(57) ABSTRACT

In a method 500 of controlling cloud services a single cloud services controller system 110 presents a plurality of cloud services portals 205 for facilitating self-service interaction. The plurality of cloud services portals 205 that are presented include: a consumer services portal 205-1, a design services portal 205-2, an administrative services portal 205-3, an operations management services portal 205-4, and a business management services portal 205-n. Based upon interaction received via one or more of the cloud services portals 205, an instantiation of resources 260 with which to provide a requested cloud-based service is determined. The instantiation of resources 260 is actuated in a data center 130 via interaction with existing data center management capabilities 131 to affect implementation of the requested cloud-based service within the data center 130.

### BACKGROUND

Presently, customers for information technology (IT) services are able to order many IT services that are remotely implemented and provided by data centers. These data centers may be located far away from the customer, and as such services are often referred to as “cloud services,” “cloud-based services,” or being provided by/from a “cloud.” From a customer perspective, a cloud is a term used to discuss an abstract location(s) that runs software, provides computing power, and stores data. The cloud is an abstract location, from the point of view of a customer, in the sense that typically a customer of remote services neither knows nor cares where the resources are located, only that a service is provided. From a service provider perspective, the cloud is (typically) a data center used to provide customers with remote access to IT capabilities.

Such cloud-based services can be economical and convenient for the IT customer as a wide variety of IT services including services such as databases, web servers, internet protocol trackers, online storage and more are provided remotely in exchange for a fee. When there is a remoteness involved between the user and the provider of IT services, the responsibilities for managing details generally get shifted in some way or another as contrasted with a customer running their own data center. This relieves the customer of buying actual equipment and software to assemble such IT services. This also relieves the customer of needing to provide space, electricity, and climate control that are required for locally implemented IT services. This can also reduce the workload on the customer as the most or all software and hardware maintenance for these remotely provided IT services is provided by personnel employed by the data center or some other remote entity, and not by a local staff of the customer.

### BRIEF DESCRIPTION OF THE DRAWINGS

The accompanying drawings, which are incorporated in and form a part of this specification, illustrate various embodiments of the present invention and, together with the description of embodiments, serve to explain principles discussed below. The drawings referred to in this brief description of the drawings should not be understood as being drawn to scale unless specifically noted.

FIG. 1 is an example block diagram of a cloud platform that includes a cloud services controller system, in accordance with an embodiment.

FIG. 2 is an example block diagram of a cloud services controller system, in accordance with an embodiment.

FIG. 3 is an expanded block diagram of a selection of services portals provided by a cloud services controller system, in accordance with an embodiment.

FIG. 4 is a graph relating cost and complexity of providing cloud-based services versus maturity of a cloud services controller system, in accordance with an embodiment.

FIG. 5 is a flow diagram of a method of controlling cloud services, according to an embodiment.

FIG. 6A is a flow diagram of a second method of controlling cloud services, according to an embodiment.

FIG. 6B is a continuation of the flow diagram of FIG. 6A, according to various embodiments.

FIG. 7 is a block diagram of an example computer system, according to an embodiment, with which or upon which embodiments of the present invention can be implemented.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “presenting,” “determining”, “actuating,” “providing,” “receiving,” “assigning,” “changing,” “reporting,” “discovering,” “instituting,” or the like, often refer to the actions and processes of an electronic computing device or system, such as a cloud services controller system, among others. The electronic computing device/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Overview of Discussion

Remotely provided information technology (IT) services may be hardware services (e.g., processing and/or storage), software services (which inherently run on hardware), or some combination thereof. These remote IT services are broadly described herein as “cloud-based services.” A cloud services market is a market that provides cloud-based services. A cloud services market comprises various ecosystems with roles and responsibilities. Cloud-based services in the cloud services market are defined by understanding where exchanges of information between roles are needed to satisfy responsibilities. Conventionally, roles and responsibilities in cloud services are handled in a fragmented, piecemeal manner which adds cost and complexity from the perspectives of both a customer and provider of remote information technology services.

Herein, a cloud services market is described which comprises a layered framework of cloud computing that uses a cloud platform(s) to provide cloud services. With respect to this framework, and as described herein, a cloud services controller system is provided as the central operating system of the cloud platform. Various examples of a cloud services controller system, and operation thereof for controlling cloud services, are described herein. It is appreciated that, in one embodiment, the cloud controller system described herein provides web-based services which are accessed by users via one or more web-based portals, which is very different than being web-browser based (e.g., an application that runs locally through a browser rather than remotely from a user).

The cloud services controller system provides a centralized and highly integrated system which supports a plurality of portals for exchanging information between the various roles in a cloud services market in order to fulfill responsibilities. This allows management of the lifecycle of user services which are broadly defined as ranging from physical servers to virtual servers, to databases, to web servers, to web applications and services, to accounts. Thus, a homogeneous selection of user services are dealt with rather than merely dealing with a much less complex and homogeneous set of user services such as only the delivery of virtual machines in a virtual datacenter. As will become apparent, because of the heterogeneous nature of the cloud services controller system described herein, the system can be upgraded by individually removing, replacing, or adding components or services of its architecture. Similarly, a user of the system can have access to various levels of service depending upon the services, portals, or portions thereof that a user is allowed to access.

Discussion will begin with a description of an example block diagram of a cloud platform that includes a cloud services controller system shown in relation to other components of the cloud platform. Aspects of the cloud platform will be discussed. Operation of components of an example cloud services controller system will then be discussed, to include a discussion of a plurality of self-service capabilities provided by the cloud services controller system via portals. Cost and complexity of providing cloud-based services will then be discussed. Operation of the cloud services controller system will be further described in conjunction with discussion of two example methods controlling cloud services. Finally, discussion will move to description of an example computer system with which or upon which various embodiments of the present invention can be implemented.

### Cloud Platform

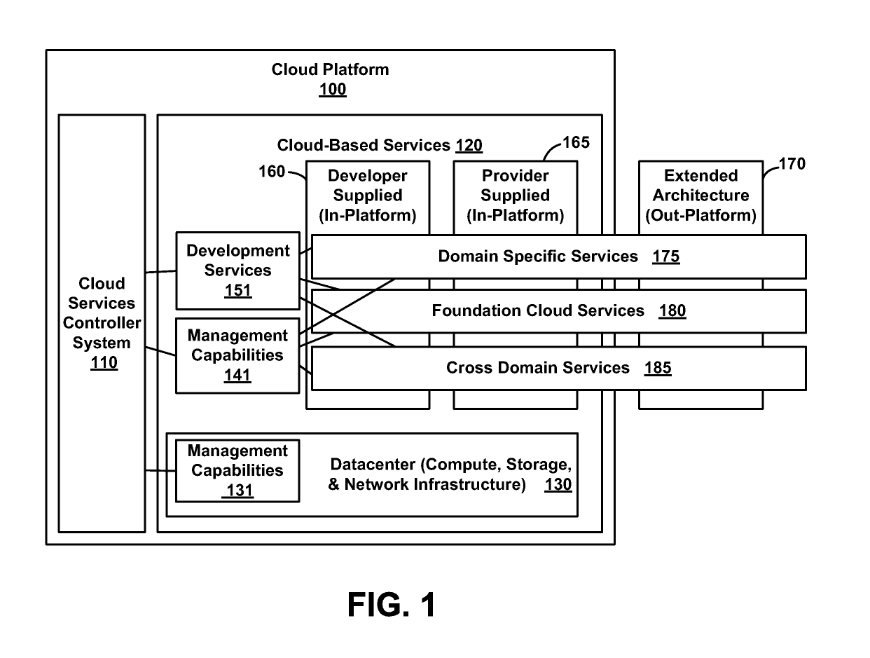

FIG. 1 is an example block diagram of a cloud platform 100 that includes a cloud services controller system 110, in accordance with an embodiment. Cloud platform 100 is an execution environment for running software code and hardware remotely (e.g., in a cloud) and for specifying a division of roles and responsibilities between what a customer of a cloud-based service 120 CaO do with respect to operation and/or interaction with the cloud-based service 120, and what a provider and/or other role-player can do with respect to the cloud-based service. Cloud services controller system 110 is a single comprehensive orchestrating infrastructure that provides a plurality self-service capabilities through both cloud-based service customers' and cloud-based service providers' portals. These self-service capabilities interact with and control existing management and development capabilities to facilitate centralized access and a higher level of function that was previously available from disparate sources. From the single orchestrating infrastructure of cloud services controller system 110, these portals for self-service capabilities provide a plurality of mechanisms and interfaces for design, consumer interaction, administration, operational management, and business management of cloud-based services 120 and for interaction with, management of, and administration of the resources of a data center(s) 130 and/or other compute, storage, and network infrastructure that provides the resources which make up cloud-based services 120.

As shown in FIG. 1, cloud services controller system 110 is communicatively coupled with existing management capabilities 131 of one or more data centers 130, as well as with existing management capabilities 141 and development services 151 that span a range of available cloud-based services 120 (e.g., domain specific services 175, foundation cloud services 180, and cross domain services 185). It is appreciated that the range of cloud-based services 120 comprise those that are developer supplied 160 (designed and provided by an outside entity, such as a developer group that works with the resources of data center 130 but is a separate business/organization from an application service provider), provider supplied 165 (e.g., designed and supplied by an application service provider), and/or are part of an extended architecture 170 (e.g., provided using resources other than those of data center 130).

Cloud Services Controller System

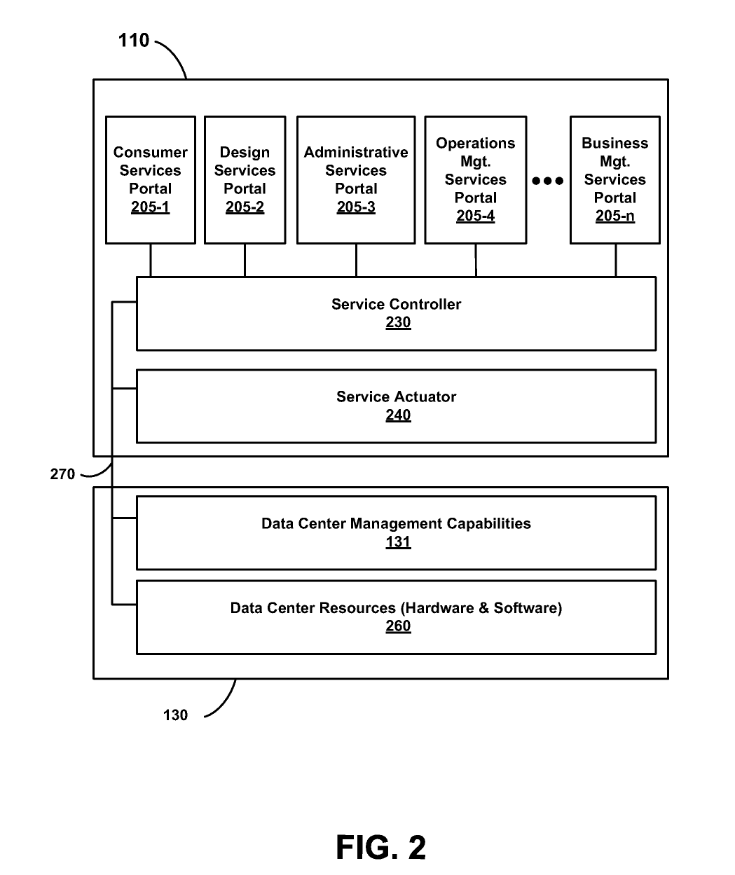

FIG. 2 is an example block diagram of a cloud services controller system 110, in accordance with an embodiment. As depicted in FIG. 2, cloud services controller system 110 comprises a service controller 230 that is communicatively coupled 270 with a service actuator 240. Additionally, both service controller 230 and service actuator 240 are communicatively coupled 270 with data center management capabilities 131 and data center resources 260 of data center 130. Communicative coupling 270 is depicted in FIG. 2 as a bus, but can comprise independent or community coupling of other form as are well known. As depicted in FIG. 2, service controller 230 acts as a single orchestrating infrastructure that presents a plurality of distinct services portals 205 (e.g., consumer services portal 205-1, design services portal 205-2, administrative services portal 205-3, operations management services portal 205-4, and business management services portal 205-n). It is appreciated that an additional number of services portals are presented by service controller 230 in other embodiments. It is also appreciated that, in other embodiments, additional components and/or functions may be included in cloud services controller system 110 and that components/functions may be combined in various ways other than those depicted.

Cloud services controller system 110 exists in an operational space that is between the sellers of data center resources (e.g., Amazon's Elastic Compute Cloud) and customers of such data center resources, designers of cloud-based services, and/or business which buy/lease such data center resources and package them into cloud-based services for resale or offer to customers. Conventionally, in the absence of cloud services controller system 110, application developers and/or customers of cloud platforms: go without functions provided by services portals 205; use one or more stand alone products that do not operate or interact with one another; or write custom code for performing a single function that may be but one of the functions provided by a services portal 205 (this is analogous to a software developer for a personal computer being required to write a significant portion of the personal computer's operating system for each application developed for the personal computer).

Cloud services controller system 110 exists in one sense as an operating system for executing a plurality of services, via service portals 205, which provide capabilities for various roles and their responsibilities within cloud platform 100. Thus, within the single infrastructure of cloud services controller system 110, service portals 205 are presented in an interlinked and orchestrated fashion for a variety of role-players, including: customers, designers, administrators, operations manages, and business managers. It is appreciated that in non-cloud implementations (e.g., in customer owned/operated resources) of IT services that are similar to cloud-based services 120 many of these roles are actually combined and/or performed by a single IT organization. However, when the shift is made to a cloud-based service these roles are dispersed, sometimes to multiple different organizations/businesses in disparate locations. Cloud services controller system 110 provides, from a single orchestrating infrastructure, services portals that face these roles that exist with respect to design, consumption, administration, and management of cloud-based services.

Service controller 230, in one embodiment, receives input from and provides output to services portals 205. For example, service controller 230 receives interaction via one or more of cloud services portals 205 and, based on the received interaction, determines an instantiation of resources with which to provide a requested cloud-based service. In this manner, service controller 230 coordinates different activities, invoked by self-service interactions by various role-players, and instructs actuator 240 to institute, change, terminate, or after a cloud-based service or resource within data center 130. Additionally, via interaction with data center management capabilities 131 and/or data center resources 260, service controller 230 discovers or gains visibility into resources which can be assigned to an instantiation of a design/model of a cloud-based service that is or may be offered to a customer.

With respect to a determination of an instantiation of resources that is made based on the received interaction, consider as an example, an embodiment where service controller 230 receives and tests a design of a cloud-based service 120 via interactions through design services portal 205-2; places a price on the cloud-based service 120 based on an interaction via business management services portal 205-n; communicates with data center management capabilities 131 and/or data center resources 260 and determines an instantiation of available resources from data center 130 with which to build/provide the cloud-based service 120; presents a customer with a browsable online catalog from which the customer requests/purchases the cloud-based service 120 via interaction through consumer services portal 205-1; and allows a business manager to compile a sales report on the cloud-based service 120 via an interaction via business management services portal 205-n.

Additionally, service controller 230 interacts with data center resources 260 and data center management capabilities 131 to: monitor data center resources 260 (hardware and software) that are being utilized in a cloud-based service provided to a customer; affect changes/alterations to resources used to provide cloud-based services; and/or discover available data center resources 260 that can serve as an instantiation, or be combined into an instantiation, of a cloud-based service that has been designed by a designer and/or offered for sale to a customer by a business manager. As non-limiting examples, an administrator may monitor the account of a customer or view available assets/resources via an interaction through administrative services portal 205-3; an operations manager may patch software or initiate maintenance of resources used to provide cloud-based service 120 via interaction through operations management services portal 205-4; a business manager may generate a bill to a customer via an interaction through business management services portal 205-n; and the customer can then access the bill and change or terminate the cloud-based service 120 via interaction through consumer services portal 205-1

Service actuator 240 is communicatively coupled with service controller 230 and actuates an instantiation of resources, such as an instantiation of resources 260 in data center 130, via interaction with existing data center management capabilities 131 to affect the actual creation of a customer requested/purchased cloud-based service 120. Service actuator 240 makes changes to the resources 260 of data center 130 by communicatively interacting to control existing data center management capabilities 131, rather than duplicating them. In some embodiments, service actuator 240 also interacts directly with data center resources 260. Some non-limiting examples of interactions include: combining an instantiation of resources to create and initiate a cloud-based service 120; instituting changes to the resources 260 such as software patches/upgrades; swapping or altering resources in response to a degradation or failure of a resource or a change requested by a customer; and/or releasing resources when a cloud-based service 120 is terminated. In one embodiment, service actuator 240 makes changes to resources 260 in response to a self-service interaction received via a service portal 205. In some embodiments, service actuator 240 additionally makes compensatory changes automatically in response to service controller 230 detecting the failure/degradation of a resource of data center 130 that provides a cloud-based service 120 to a customer of cloud services controller system 110.

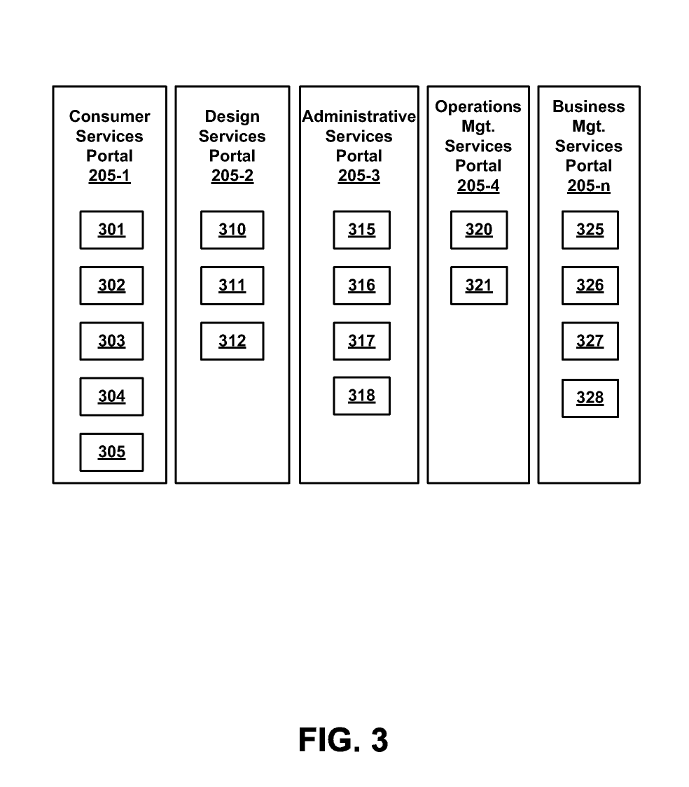

FIG. 3 is an expanded block diagram of a selection of services portals 205 provided by cloud services controller system 110, in accordance with an embodiment. FIG. 3 illustrates one example of a selection of interfaces and mechanism that are presented by services portals 205, in accordance with an embodiment.

With reference to FIG. 3, an embodiment of consumer services portal 205-1 is depicted as including: a catalog 301 of cloud-based services 120 that a consumer can browse and request/purchase; an order interface 302 for requesting/purchasing a cloud-based service 120 and tracking delivery/fulfillment of an requested/purchased cloud-based service 120; an operations interface 303 for requesting changes in a cloud-based service 120 (e.g., requesting more or less storage capacity, bandwidth, processing power and/or requesting that a cloud-based service 120 be terminated); a billing interface 304 for receiving and responding to (e.g., paying/disputing) bills for cloud-based services 120 that have been purchased; and a reporting interface 305 for requesting reports on the use and/or operation of a customer's cloud-based service (e.g., a report on how much of the capacity of a cloud-based service 120 is being utilized over a period of time).

With continued reference to FIG. 3, an embodiment of design services portal 205-2 is depicted as including: a design interface 310 that allows designers to make or upload models of cloud-based services (e.g., templates for the assembly of resources of data center 130 into cloud-based services 120); a test interface 311 that allows a designer to implement a model of a cloud-based service 120 in actual resources of data center 130 to test its functionality and/or to virtually test the operation of the model of the cloud-based service 120; and a roll-out interface 312 for posting models of cloud-based services that are ready for customer use.

With continued reference to FIG. 3, an embodiment of administrative services portal 205-3 is depicted as including: an account interface 315 for facilitating administrator management of accounts on cloud services controller system 110; a policy interface 316 for setting/changing policies with respect to operation and interaction with cloud services controller system 110: a state of health interface 317 for requesting/accessing metrics on operations cloud-based services 120, resources of data center 130, and other operations/functions of cloud services controller system 110; and a resource tracking interface 318 for requesting/viewing lists of utilized and/or available resources in data center 130.

With continued reference to FIG. 3, an embodiment of operations management services portal 205-4 is depicted as including: a change interface 320 for directing changes such as software loads, configuration setting changes, and/or hardware/software swaps or changes to be implemented with respect to resources 260 of data center 130; and a patch interface 321 for directing installation of software and/or firmware patches to resources 260 of data center 130.

With continued reference to FIG. 3, an embodiment of business management services portal 205-n is depicted as including: a pricing interface 325 for assigning a price to a rolled-out cloud-based service 120 and for adding/changing cloud-based services 120 that are offered in catalog 301; a reports interface 326 for generating profit/loss statements based upon expenses and income or projections thereof, allocation/usage reports related to resources 260, and other information for understanding the cash flows associated with operating resources 260 in data center 130; a supply-chain interface 327 for viewing the roles and responsibilities involved in providing a cloud-based service 120; and a what-if interface 328 for proposing new cloud-based services 120 to be offered to customers and/or designed by designers.

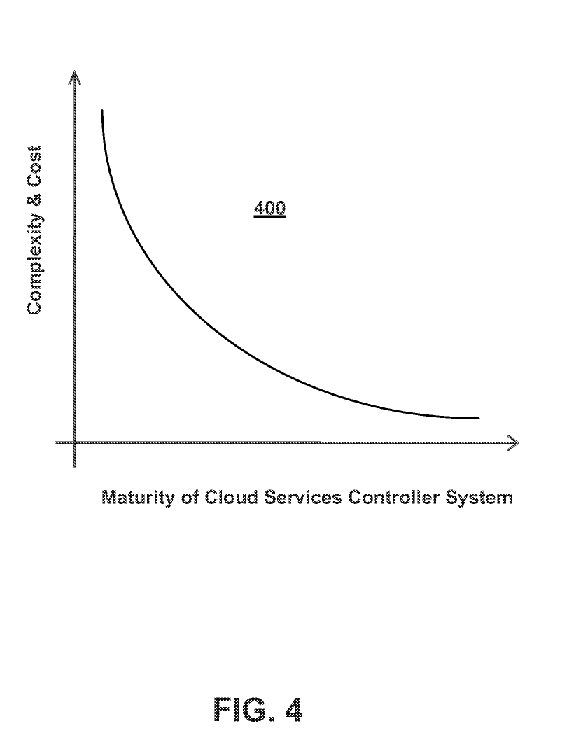

FIG. 4 is graph 400 relating cost and complexity of providing cloud-based services versus maturity of a cloud services controller system 110, in accordance with an embodiment. As evident from graph 400, consolidating a selection of mature components in cloud services controller system 110 reduces cost and complexity for both customers and other actors (designers, business managers, administrators, operations manages, and the like) that are involved with creating, offering, maintaining, and/or using cloud-based services 120. It is appreciated that the conventional fragmented and disparate mechanisms which are utilized to control cloud services have a greater cost and complexity than an immature (left side of graph 400) cloud services controller system 110.

### Example Methods of Operation

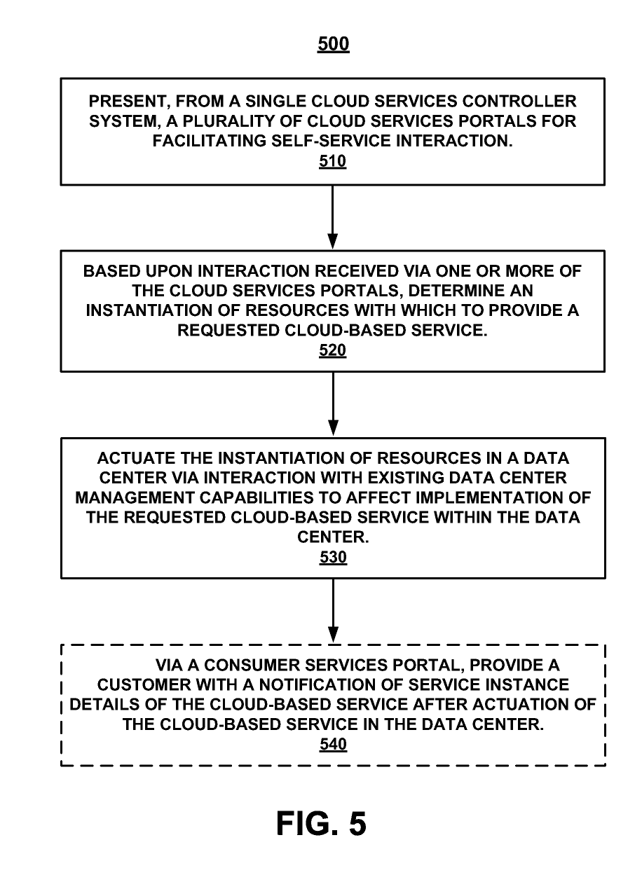

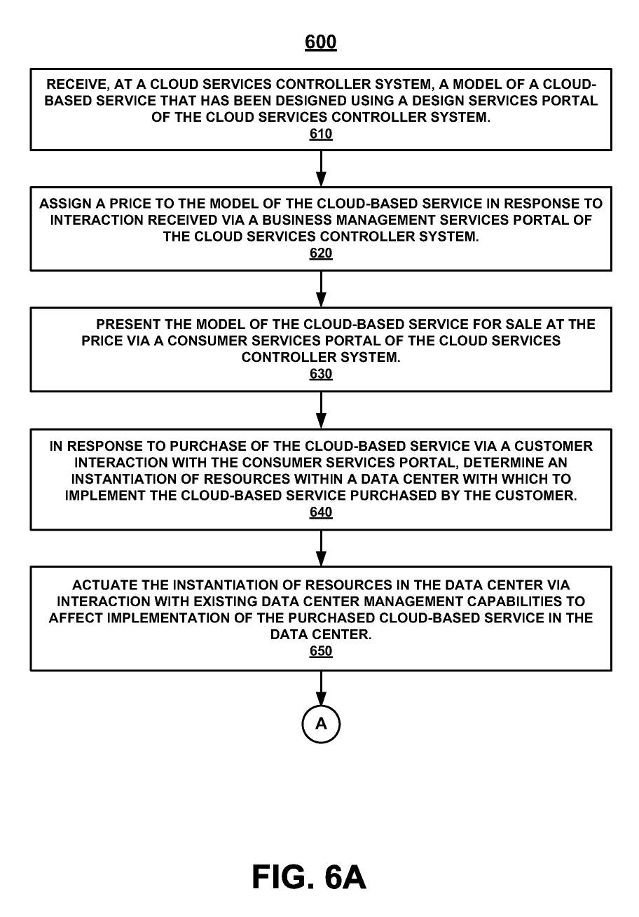

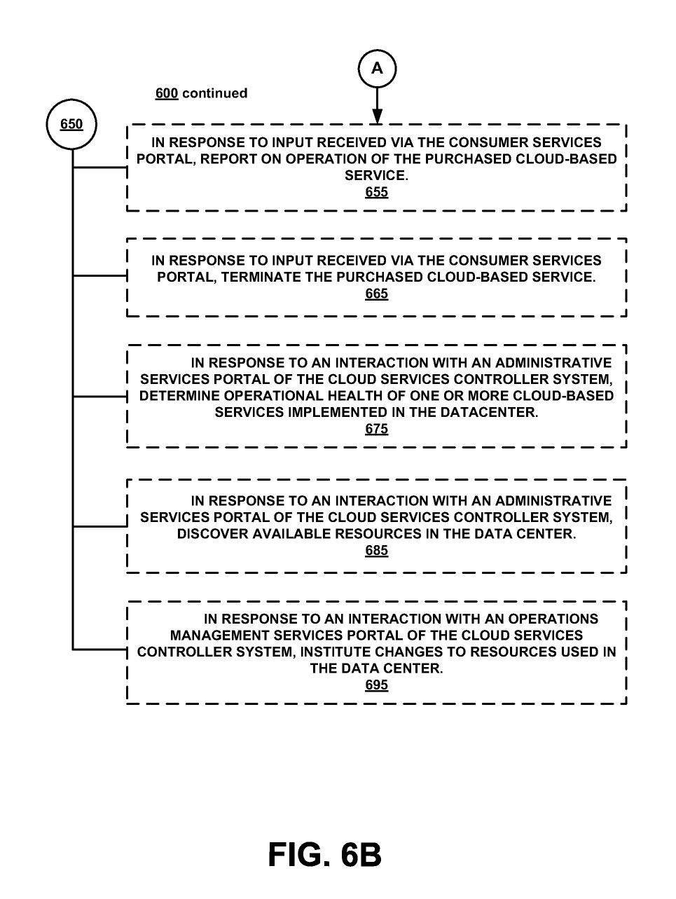

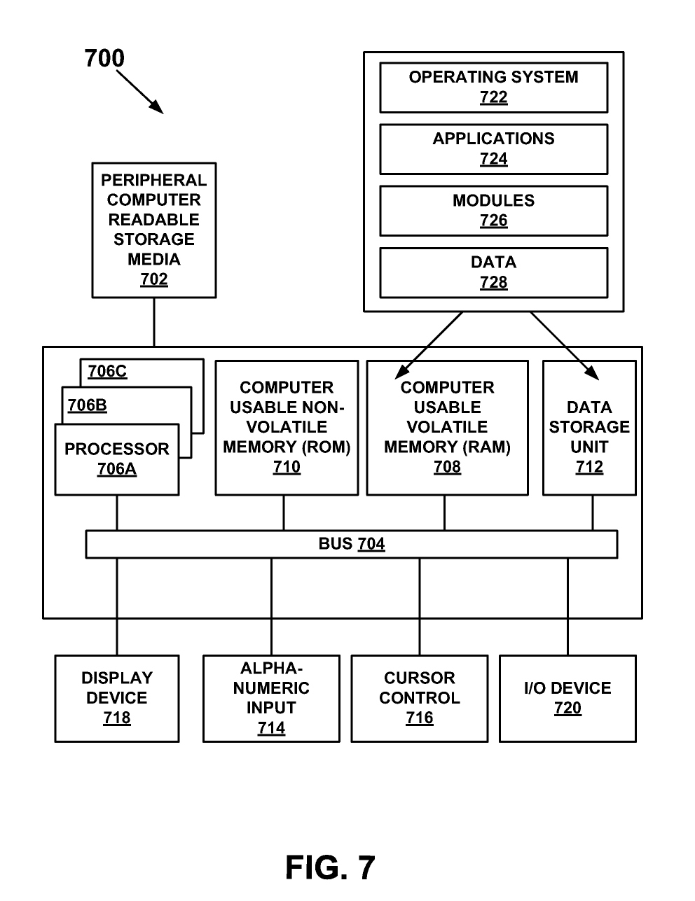

The following discussion sets forth in detail the operation of some example methods of operation of embodiments. With reference to FIG. 5, FIG. 6A and FIG. 6B, flow diagrams 500 and 600 illustrate example procedures used by various embodiments. Flow diagrams 500 and 600 include some procedures that, in various embodiments, are carried out by a processor under the control of computer-readable and computer-executable instructions. In this fashion, one or both of flow diagrams 500 and 600 are implemented using a computer, in various embodiments. The computer-readable and computer-executable instructions can reside in any tangible computer readable storage media, such as, for example, in data storage features such as computer usable volatile memory 708, computer usable non-volatile memory 710, peripheral computer-readable storage media 702, and/or data storage unit 712 (all of FIG. 7). The computer-readable and computer-executable instructions, which reside on tangible computer readable storage media, are used to control or operate in conjunction with, for example, one or some combination of processors 706A, 706B, and 706C of FIG. 7, or other similar processor(s). Although specific procedures are disclosed in flow diagrams 500 and 600, such procedures are examples. That is, embodiments are well suited to performing various other procedures or variations of the procedures recited in flow diagrams 500 and 600. Likewise, in some embodiments, the procedures in flow diagrams 500 and 600 may be performed in an order different than presented and/or not all of the procedures described in one or both of these flow diagrams may be performed.

### Example Method of Controlling Cloud Services

FIG. 5 illustrates a flow diagram 500 of an example embodiment of a method of controlling cloud services. Flow diagram 500 also describes a method of using cloud services controller system 110, according to an embodiment. Elements of flow diagram 500 are described below, with reference to elements of FIGS. 1-3.

At 510 of flow diagram 500, in one embodiment, the method presents, from a single cloud services controller system, a plurality of cloud services portals for facilitating self-service interaction. In one embodiment, this comprises cloud services controller system 110 presenting and orchestrating a plurality of services portals 205 for a variety of role-players. In one embodiment, such service portals 205 include: consumer services portal 205-1, design services portal 205-2, administrative services portal 205-3, operations management services portal 205-4, and business management services portal 205-n. It is appreciated that, in some embodiments, additional and/or different combinations of services portals 205 can be presented by cloud services controller system 110.

At 520 of flow diagram 500, in one embodiment, the method determines an instantiation of resources with which to provide a requested cloud-based service. This determination is based upon interaction received via one or more of the presented cloud services portals. In one embodiment, this comprises cloud services controller system 110 receiving interaction from one or more of cloud services portals 205 and service controller 230 determining an instantiation of resources 260 with which to implement and provide the requested cloud-based service 120.

The operation at 520 of flow diagram 500 can occur in response to a single or small set of interactions, such as a customer requesting/purchasing a cloud-based service from catalog 301 via an interaction with consumer services portal 205-1. Similarly, in one embodiment, service controller 230 determines changes to an instantiation of resources (e.g., addition, removal, or swapping of resources) needed to implement a requested change to a customer's cloud-based service 120. Such changes are determined, in one embodiment, in response to a change input received via operations interface 303 of consumer services portal 205-1. It is appreciated that in various embodiments, the cloud-based service 120 is designed and/or tested via interaction accomplished by a designer with design services portal 205-2.

The operation at 520 of flow diagram 500 can also occur in response to a chain of several interactions with one or more services portals 205. In one embodiment, for example, such a chain of interactions comprises; receiving a roll-out of a model of a cloud-based service 120 via a designer interacting with design services portal 205-2; in response to interaction with pricing interface 325 of business management services portal 205-n, assigning a price to the model of the cloud-based service 120 and presenting the model for sale to a customer at the assigned price; and service controller 130 then determines an instantiation of resources 260 from data center 130 with which to implement the requested cloud-based service 120 (e.g., in response to offering the cloud-based service 120 for sale or in response to receiving a customer request for the cloud-based service 120). It is appreciated that in various embodiments, the cloud-based service 120 is designed and/or tested via interaction accomplished by a designer with design services portal 205-2 before being rolled-out.

At 530 of flow diagram 500, in one embodiment, the method actuates the instantiation of resources in a data center via interaction with existing data center management capabilities to affect implementation of the requested cloud-based service within the data center. In this manner, service actuator 240 “touches” or interacts with the resources 260 of data center 130 and/or with existing data center management capabilities 131 to initiate and implement the requested cloud-based service 120 from the planned instantiation of resources that is provided by service controller 230.

At 540 of flow diagram 500, in one embodiment, the method provides a customer with a notification of service instance details of the cloud-based service after actuation of the cloud-based service in the data center. For example, in one embodiment, this comprises service controller 230 providing a customer notification (e.g., a message) via order interface 302 of consumer services portal 205-1 so that a customer will know that the order/request of a cloud-based service has been fulfilled and is operational. Likewise, other status updates prior to and after fulfillment can be provided in a similar manner. Additionally, billing for the requested cloud-based service can be pushed from service controller 230 to billing interface 304 and/or reports on the operation of a customers cloud-based service can be pushed from service controller 230 to reporting interface 305.

### Second Example Method of Controlling Cloud Services

FIGS. 6A and 6B illustrate a flow diagram 600 of a second example embodiment of a method of controlling cloud services. Flow diagram 600 also describes a method of using cloud services controller system 110, according to an embodiment. Elements of flow diagram 600 are described below, with reference to elements of FIGS. 1-3.

At 610 of flow diagram 600, in one embodiment, the method receives a model of a cloud-based service that has been designed using a design services portal of the cloud services controller system. In one embodiment, this comprises cloud services controller system 110 receiving a rolled-out model of a cloud-based service 120 via roll-out interface 312 of design services portal 205-2. It is appreciated that, in various embodiments, the rolled-out model of the cloud-based service 120 is designed and/or tested via interaction accomplished by a designer with design services portal 205-2.

At 620 of flow diagram 600, in one embodiment, the method assigns a price to the rolled-out model of the cloud-based service 120. In one embodiment, this comprises assigning the price in response to interaction received via pricing interface 325 of business management services portal 205-n.

At 630 of flow diagram 600, in one embodiment, the method presents the rolled-out and priced model of the cloud-based service for sale at the assigned price. In one embodiment, this comprises service controller 230 placing the priced model into a catalog 301 for access via consumer services portal 205-1.

At 640 of flow diagram 600, in one embodiment, the method determines an instantiation of resources within a data center with which to implement the cloud-based service purchased or requested by a customer. In one embodiment, this comprises service controller 230 determining the resource 260 or assemblage of resources 260 (guided by the model), within data center 130 with which to create an instance of the requested cloud-based service 120. In one embodiment, service controller 230 undertakes this determination in response to purchase/request of the cloud-based service via a customer interaction with, for example, catalog 301 and/or order interface 302 of consumer services portal 205-1. It is appreciated that this determination can also be undertaken at other points, such as upon the roll-out or pricing of a model of a cloud-based service 120.

At 650 of flow diagram 600, in one embodiment, the method actuates the instantiation of resources in the data center. In one embodiment, this comprises service actuator 240 interacting with data center resources 260 and/or controlling existing data center management capabilities 131 to affect implementation of the purchased cloud-based service 120 in data center 130.

At 655 of flow diagram 600, in one embodiment, the method further includes reporting on operation of the purchased cloud-based service 120. In one embodiment, this comprises generating a report on the operation (e.g., a report on the availability and/or utilization) of the cloud-based service 120 in response to input received via reporting interface 305 (e.g., a request for a report) of consumer services portal 205-1.

At 665 of flow diagram 600, in one embodiment, the method further includes terminating the requested/purchased cloud-based service 120. In one embodiment, this termination is accomplished by service actuator 240 in response to service controller 230 receiving an input from operations interface 303 (e.g., a request for termination of cloud-based service 120) via consumer services portal 205-1.

At 675 of flow diagram 600, in one embodiment, the method further includes determining operational health of one or more cloud-based services that are implemented in the data center. In one embodiment, this comprises service controller 230 providing operational metrics regarding one or more cloud-based services in response to receiving a request for such metrics via an interaction with state of health interface 317 of administrative services portal 205-3.

At 685 of flow diagram 600, in one embodiment, the method further includes discovering available resources in data center 130. In one embodiment, service controller 230 may intermittently/routinely accomplish such discovery via communication with data center 130. In one embodiment, service controller 230 undertakes this discovery in response to an interaction (e.g., a request for a listing of available resources) with resource tracking interface 318 of administrative services portal 205-3.

At 695 of flow diagram 600, in one embodiment, the method further includes instituting changes to hardware or software used in the data center. This can comprise installing new software, patching software or firmware, upgrading software or firmware, altering settings of resources, assigning or changing licenses, swapping hardware or moving existing software to new hardware, and the like. In one embodiment, the change is instituted in response to an interaction (e.g., a request for a change) that is received via change interface 320 of operations management services portal 205-4.

### Example Computer System Environment

With reference now to FIG. 7, all or portions of some embodiments described herein are composed of computer-readable and computer-executable instructions that reside, for example, in computer-usable/computer-readable storage media of a computer system. That is, FIG. 7 illustrates one example of a type of computer (computer system 700) that can be used in accordance with or to implement various embodiments which are discussed herein. It is appreciated that computer system 700 of FIG. 7 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, server blades, and the like. Computer system 700 of FIG. 7 is well adapted to having peripheral computer-readable storage media 702 such as, for example, a floppy disk, a compact disc, a digital versatile disc (DVD), a USB (universal serial bus) flash memory drive and the like coupled thereto.

System 700 of FIG. 7 includes an address/data bus 704 for communicating information, and a processor 706A coupled to bus 704 for processing information and instructions. As depicted in FIG. 7, system 700 is also well suited to a multi-processor environment in which a plurality of processors 706A, 706B, and 706C are present. Conversely, system 700 is also well suited to having a single processor such as, for example, processor 706A. Processors 706A, 706B, and 706C may be any of various types of microprocessors. System 700 also includes data storage features such as a computer usable volatile memory 708, e.g. random access memory (RAM), coupled to bus 704 for storing information and instructions for processors 706A, 706B, and 706C. System 700 also includes computer usable non-volatile memory 710, e.g. read only memory (ROM), coupled to bus 704 for storing static information and instructions for processors 706A, 706B, and 706C. Also present in system 700 is a data storage unit 712 (e.g., a magnetic or optical disk and disk drive) coupled to bus 704 for storing information and instructions.

In some embodiments, system 700 also optionally includes other components. For example, system 700 also includes an optional alphanumeric input device 714 including alphanumeric and function keys coupled to bus 704 for communicating information and command selections to processor 706A or processors 706A, 706B, and 706C. System 700 also includes an optional cursor control device 716 coupled to bus 704 for communicating user input information and command selections to processor 706A or processors 706A, 706B, and 706C. In one embodiment, system 700 also includes an optional display device 718 coupled to bus 704 for displaying information.

Referring still to FIG. 7, optional display device 718 of FIG. 7 may be a liquid crystal device, cathode ray tube, plasma display device or other display device suitable for creating graphic images and alphanumeric characters recognizable to a user. Optional cursor control device 716 allows the computer user to dynamically signal the movement of a visible symbol (cursor) on a display screen of display device 718 and indicate user selections of selectable items displayed on display device 718. Many implementations of cursor control device 716 are known in the art including a trackball, mouse, touch pad, joystick or special keys on alpha-numeric input device 714 capable of signaling movement of a given direction or manner of displacement. Alternatively, it will be appreciated that a cursor can be directed and/or activated via input from alpha-numeric input device 714 using special keys and key sequence commands. System 700 is also well suited to having a cursor directed by other means such as, for example, voice commands. System 700 also includes an I/O device 720 for coupling system 700 with external entities. For example, in one embodiment, I/O device 720 is a modem for enabling wired or wireless communications between system 700 and an external network such as, but not limited to, the Internet.

Referring still to FIG. 7, various other components are depicted for system 700. Specifically, when present, an operating system 722, applications 724, modules 726, and data 728 are shown as typically residing in one or some combination of computer usable volatile memory 708 (e.g., RAM), computer usable non-volatile memory 710 (e.g., ROM), and data storage unit 712. In some embodiments, all or portions of various embodiments described herein are stored, for example, as an application 724 and/or module 726 in memory locations within RAM 708, computer-readable storage media within data storage unit 712, peripheral computer-readable storage media 702, and/or other tangible computer readable storage media.

Example embodiments of the subject matter are thus described. Although various embodiments of the subject matter have been described in a language specific to structural features and/or methodological acts, it is to be understood that the appended claims are not necessarily limited to the specific features or acts described above. Rather, the specific features and acts described above are disclosed as example forms of implementing the claims and their equivalents.

What is claimed is:

1. A computer-readable storage medium 702, 708, 710 having instructions stored thereon which, when executed, cause a computer processor 706 to perform a method 500 of controlling cloud services, said method comprising instructions for:
presenting 510, from a single cloud services controller system, a plurality of cloud services portals for facilitating self-service interaction, said plurality of cloud services portals including a consumer services portal, a design services portal, an administrative services portal, an operations management services portal, and a business management services portal;
based upon interaction received via one or more of said cloud services portals, determining 520 an instantiation of resources with which to provide a requested cloud-based service; and
actuating 530 said instantiation of resources in a data center via interaction with existing data center management capabilities to affect implementation of said requested cloud-based service within said data center.

2. The computer-readable storage medium 702, 708, 710 of claim 1, further comprising instructions for:
via said consumer services portal, providing 540 a customer with a notification of service instance details of said cloud-based service after actuation of said cloud-based service in said data center.

3. The computer-readable storage medium 702, 708, 710 of claim 1, wherein said based upon interaction received via one or more of said cloud services portals, determining 520 an instantiation of resources with which to provide a requested cloud-based service comprises:
receiving a model of said cloud-based service via said design services portal, wherein said model is designed and tested via interaction accomplished with said design services portal.

4. The computer-readable storage medium 702, 708, 710 of claim 3, wherein said based upon interaction received via one or more of said cloud services portals, determining 520 an instantiation of resources with which to provide a requested cloud-based service further comprises:
in response to interaction via said business management services portal, assigning a price to said model of said cloud-based service; and
via said consumer services portal, presenting said model of said cloud-based service for sale to a customer at said price.

5. The computer-readable storage medium 702, 708, 710 of claim 1, wherein said based upon interaction received via one or more of said cloud services portals, determining 520 an instantiation of resources with which to provide a requested cloud-based service comprises:
based upon request of an offered cloud-based service via said consumer services portal, determining said instantiation of resources with which to implement said requested cloud-based service, said cloud-based service designed using said design services portal.

6. The computer-readable storage medium 702, 708, 710 of claim 5, further comprising instructions for:
in response to a change input received via said consumer services portal, determining an change to said instantiation of resources.

7. A computer-implemented method 600 of controlling cloud services, said method 600 comprising:
receiving 610, at a cloud services controller system, a model of a cloud-based service that has been designed using a design services portal of said cloud services controller system;
assigning 620 a price to said model of said cloud-based service in response to interaction received via a business management services portal of said cloud services controller system;
presenting 630 said model of said cloud-based service for sale at said price via a consumer services portal of said cloud services controller system;
in response to purchase of said cloud-based service via a customer interaction with said consumer services portal, determining 640 an instantiation of resources within a data center with which to implement said cloud-based service purchased by said customer: and
actuating 650 said instantiation of resources in said data center via interaction with existing data center management capabilities to affect implementation of said purchased cloud-based service in said data center.

8. The computer-implemented method 600 as recited in claim 7, further comprising:
in response to input received via said consumer services portal, reporting 655 on operation of said purchased cloud-based service.

9. The computer-implemented method 600 as recited in claim 7, further comprising:
in response to input received via said consumer services portal, terminating 665 said purchased cloud-based service.

10. The computer-implemented method 600 as recited in claim 7, further comprising:
in response to an interaction with an administrative services portal of said cloud services controller system, determining 675 operational health of one or more cloud-based services implemented in said data center.

11. The computer-implemented method 600 as recited in claim 7, further comprising:
in response to an interaction with an administrative services portal of said cloud services controller system, discovering 685 available resources in said data center.

12. The computer-implemented method 600 as recited in claim 7, further comprising:
in response to an interaction with an operations management services portal of said cloud services controller system, instituting 695 changes to hardware or software used in said data center.

13. A cloud services controller system 110, said system 110 comprising:
a plurality of cloud services portals 205 presented from said cloud services controller system 110 for facilitating self-service interaction, said plurality of services portals 205 including a consumer services portal 205-1, a design services portal 205-2, an administrative services portal 205-3, an operations management services portal 205-4, and a business management services portal 205-n;
a service controller 230 configured for receiving interaction via one or more of said cloud services portals 205 and based on said received interaction determining an instantiation of resources 260 with which to provide a requested cloud-based service; and
a service actuator 240 communicatively coupled 270 with said service controller 230 and configured for actuating said instantiation of resources in a data center 130 via interaction with existing data center management capabilities 131 to affect said requested cloud-based service.

14. The cloud services controller system 110 of claim 13, further comprising:
a communicative coupling 270 between said service controller 230 and hardware 260 of said data center 130.

15. The cloud services controller system 110 of claim 13, further comprising:
a communicative coupling 270 between said service actuator 240 and a set of data center management capabilities 131 that have been provided for use with said data center 130; and
a communicative coupling 270 between said service actuator 240 and hardware 260 of said data center 130.
